(19) United States
(12) Patent Application Publication
(10) Pub. No.: US 2024/0121864 A1
(43) Pub. Date: Apr. 11, 2024

(54) PTC Heating Device and Method of Manufacturing the Same

(71) Applicant: Eberspächer catem GmbH & Co. KG, Herxheim (DE)

(72) Inventors: Patrick Werner, Neuhofen (DE); Daniele Dattilo, Rhodt unter Rieburg (DE); Timo Kröner, Rülzheim (DE); Sascha Herzig, Bad Bergzabern (DE)

(21) Appl. No.: 18/376,550

(22) Filed: Oct. 4, 2023

(30) Foreign Application Priority Data
Oct. 5, 2022 (DE) 10 2022 125 637.5

(51) Int. Cl. H05B 3/48; H05B 3/14; H05B 3/18

(52) U.S. Cl. CPC H05B 3/48; H05B 3/141; H05B 3/18; H05B 2203/017; H05B 2203/02; H05B 2203/023

(57) ABSTRACT

A PTC heating device includes a frame and a heating cell accommodated in the frame. The heating cell includes at least one PTC element made of a ceramic material and contact elements to be assigned different polarity. The PTC element has contact surfaces formed by a metallization. The contact elements are each electrically contacted with one of the contact surfaces. An insulating cured compound is arranged between the outer circumference of the heating cell and the inner circumference of the frame and fixes the heating cell in the frame. An edge, formed by the ceramic material of the PTC element, between the compound and the contact surface. Also disclosed is method of forming PTC heating device according in which the PTC element is fixed to the frame by the electrically insulating compound after the compound is cured.

### BACKGROUND OF THE INVENTION

### 1. Field of the Invention

The present invention relates to a PTC heating device and a method of manufacturing the same.

### 2. Background of Related Art

The present invention is based on a PTC heating device with a frame in which a heating cell comprising at least one PTC element made of a ceramic material and contact elements to be assigned different polarity are accommodated. The PTC element has contact surfaces formed by metallization. The contact elements are electrically contacted with these contact surfaces.

The present invention relates in particular to such a PTC heating device for thermal management in a motor vehicle. Here, PTC heating devices of the type mentioned introductorily are sometimes operated at voltages higher than 12 V, which imposes special requirements on the electrical safety to be complied with. From this point of view, it is not only necessary to ensure safe electrical insulation to the outside of the parts of the heating cell carrying the power current. Rather, clearances and creepage distances must also be adapted accordingly.

It must be possible to manufacture the PTC heating device in a process-safe manner, wherein particularly economical requirements are imposed on a component in a vehicle with regard to manufacture. It is known to completely or partially surround a heating cell with a hardening compound, for example to replace air present in the frame with a better heat-conducting material.

An in particular electrically insulating compound is sometimes also used to electrically house the PTC heating cell completely or partially with the result that at least the parts carrying the power current are also covered by the electrically insulating compound inside the heating cell.

It is known that the time required to cure the compound can be reduced by heating it, for example by operating the heating cell in the course of manufacturing or by using an oven process. However, current solutions still offer room for streamlining the manufacturing process.

The underlying problem of the present invention is to provide a PTC heating device which provides good electrical safety and can be manufactured economically.

### SUMMARY

In order to solve this problem, the present invention proposes a PTC heating device with a frame in which a heating cell is arranged. The heating cell comprises a PTC element made of a ceramic material. On opposite sides, usually main side surfaces of the PTC element, a metallization is provided. This is usually produced by sputtering an electrically conductive material onto the ceramic surface of the PTC element. Contact elements, which serve to supply the power current to the PTC element, are applied in an electrically conductive manner against the regularly opposing contact surfaces formed by the metallization. These contact elements can be formed by contact sheets. However, the contact elements can also be formed by other electrically conductive structures, which can consist of one or more materials that do not necessarily have to be electrically conductive in each case. For example, it is known to use expanded metal or a wire mesh as a contact element, the free spaces of which are filled by a good heat-conducting adhesive (EP 3 515 152 A2). With regard to a defined introduction of the power current, defined contact points, which are formed by the contact element and are applied in an electrically conductive manner against the contact surface, are sometimes also preferred.

The frame can be formed from a plastic or a ceramic In any case, a material is usually selected that has very good electrical insulating properties. The frame can have beams surrounding the PTC element only. The frame may be formed in one or more parts. The frame can be formed integrally with the contact element either by itself or by a segment of the frame, in particular by overmolding the contact element with plastic. The frame is usually surmounted on one side by terminal lugs which are electrically conductively connected to the respective contact elements, preferably formed integrally by them.

An electrically insulating compound, which may be formed by silicone, for example, is provided between the inner circumference of the frame and the outer circumference of the heating cell. The compound is cured and thus dimensionally rigid. The compound serves to fix the heating cell within the frame. The compound may be located only between the outer circumference of the PTC element and the inner circumference of the frame. However, it can also be attached to the opposing inner surfaces of the contact elements. The contact elements surmount the main side surfaces of the PTC element provided with the metallization. This results in an edge-side possibly circumferential overhang of the PTC element due to the two contact elements. In order to fix the heating cell, the cured compound is located, in particular, in the gap formed between the overhangs.

An edge formed by the ceramic material of the PTC element is located between the contact surface and the cured compound. This edge may be only partially formed on a longitudinal side of the PTC element, which is usually provided in a cuboid shape. The edge may extend over an entire longitudinal side of the PTC element. The edge is typically formed as a circumferential edge on the main side surface of the PTC element. The edge creates a distance between the outer circumferential surface of the PTC element and the metallization of at least 0.1 mm. The edge spaces apart the conductive path provided on the PTC element for the power current in the form of the contact surfaces from the outer contour of the PTC element. The cured compound provided adjacent to the edge does not directly contact the metallization. These measures increase the electrical safety of the PTC heating device.

According to an implementation of the present invention, not the entire free space provided between the frame and the heating cell is filled with the compound. Rather, the compound is located only at discrete locations on the outer circumference of the heating cell. Discrete dosing of the cured compound may be provided at the outer circumference of the heating cell. This discrete dosing adequately defines the heating cell in the frame. However, dosing also may be done with a view to using as little as possible of the compound used to manufacture the PTC heating device. This not only allows material of the compound to be saved. Rather, the time required for curing the compound in the course of manufacturing the PTC heating device can also be reduced.

In order to fix the heating cell, compound is usually introduced into the frame on opposite sides between the heating cell and the frame. The compound is usually introduced at the frame, which is still open on one side. In other words, the frame or a segment of the frame is usually closed on one side, for example by attaching and connecting one of the contact elements to the frame. This side forms the lower side of the frame or frame segment during assembly. In the following, the term “frame” is also used as a synonym for “frame segment.” The PTC element is then inserted into the frame or frame segment that is open at the top.

In the process, the contact surface is applied to the contact element in an electrically conductive manner. Then, dosing of the compound into the gap between the PTC element and the frame is carried out. Dosing may be carried out such that there is no protrusion of the compound onto the main side surface of the PTC element. Appropriate volumetric dosing ensures that the compound remains within the gap and also does not protrude outward beyond the frame. However, the compound is usually introduced up to the level of the contact surface not yet occupied by a contact element. When the other contact element is subsequently placed on the PTC element, this can result in a slight displacement of the compound, as a result of which the compound is also dispensed against both inner surfaces of the contact elements and, if necessary, slightly compressed in the area of the overhang. In this way, the other contact element is regularly fixed against the PTC element and the frame through the compound.

For this fixing, it is only desired that the further contact element, which is applied later, in any case surmounts the compound with an overhang. The contact element can otherwise be adapted to the dimensions of the contact surface and accordingly be made smaller than usual. It is usual for the PTC element to be surmounted by the contact elements on its entire outer circumference. The contact element applied later can also be joined beforehand with another segment of the frame to form a preassembled unit, for example by overmolding a plastic forming the segment around the contact element.

The PTC heating device is usually part of an electrical heating device of a motor vehicle. This heating device has a heater housing with inlet and outlet openings for a medium to be heated. The housing accommodates at least one, usually more, PTC heating devices. These are coupled in a heat-conducting manner to the medium to be heated. The medium to be heated may be a liquid or gaseous medium.

In the case of a gaseous medium, there are usually insulating layers on the outside of the respective contact elements, against which corrugated fin layers abut on the outside. Usually, the electrical heating device comprises several layers of corrugated fins and PTC heating devices. This layering is usually fixed in a frame-shaped heater housing under the pretension of a spring; cf. EP 2 298 582 B1 and its U.S. counterpart 8,729,433, both incorporated herein by reference.

For installation in the electrical heating device, the PTC heating device of the type introductorily mentioned can also be arranged in a metallic housing which forms a kind of pocket into which the PTC heating device is inserted (cf. EP 3 101 364 A1 and its U.S. counterpart 10,098,183, both incorporated herein by reference). Here, too, an insulating layer is usually abutted to the outer surfaces of the contact elements so that there is no direct electrical contact between the elements of the PTC heating device carrying the power current and the housing. The housing is surmounted by the terminal lugs. The housing may also have a sealing collar which serves as a sealing plug-in contact in a partition wall of the electrical heating device, which separates a circulation chamber carrying the medium to be heated from a connection chamber of the electrical heating device, in which the terminal lugs of the PTC heating device are connected to the power current to be supplied. The connection chamber usually also accommodates a control system for the electrical heating device.

The present invention offers a plurality of advantages. By reducing the total amount of compound used, not only is material saved. Rather, the time required for curing the compound is also reduced. By reducing the volume of cured compound used and discretely dosing compound at predetermined points, overhang of compound is prevented. In particular, the compound is prevented from spreading to areas of the contact surface during manufacture, contaminating it and preventing the introduction of the power current onto the PTC element over as large an area as possible. In particular, a circumferential edge prevents contact of the compound with the contact surface and also prevents edge flashovers of the power current.

### BRIEF DESCRIPTION OF THE DRAWINGS

Further details and advantages of the present invention will be apparent from the following description of an embodiment in conjunction with the drawing. Therein:

FIG. 1 shows a perspective exploded diagram of an embodiment of an electrical heating device;

FIG. 2 shows a longitudinal sectional view of a PTC heating device of the heating device according to FIG. 1;

FIG. 3 shows a top view of parts of the embodiment of the PTC heating device in the context of assembly after the introduction of the compound;

FIG. 4 shows a view according to FIG. 3 after application of the further contact element and

FIG. 5 shows a cross-sectional view along line V-V according to FIG. 3.

### DETAILED DESCRIPTION

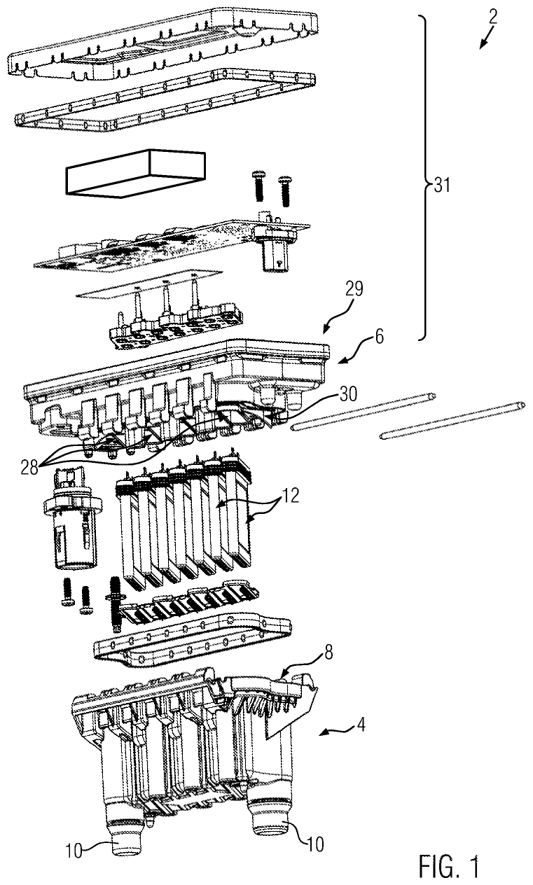

FIG. 1 shows an embodiment of an electrical heating device 2 with a multi-part heater housing comprising a housing lower part 4 formed from plastic and a housing upper part 6 formed integrally from metal by means of die casting.

The housing lower part 4 is trough-shaped and encloses a heating chamber 8 and forms inlet and outlet nozzles 10 which communicate with the heating chamber 8. These inlet and outlet nozzles 10 are integrally formed with the housing lower part 4 by injection molding. A plurality of PTC heating devices 12 are shown between the housing upper part 6 and the housing lower part 4.

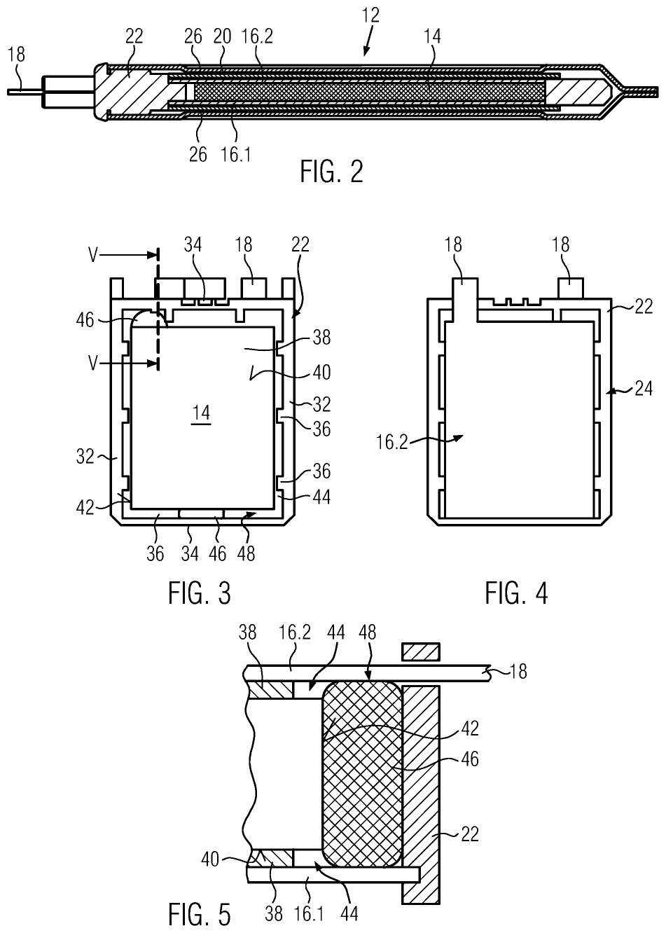

As FIG. 2 illustrates, these PTC heating devices 12 each have at least one PTC element 14 against which contact elements 16.1; 16.2 abut, which form contact tongues 18 that surmount a metallic housing 20. The PTC element 14 is accommodated in a frame 22 and between the contact elements 16.1; 16.2. Between the metallic housing and a heating cell 24 formed by the two contact elements 16.1; 16.2 and the PTC element 14, insulating layers 26 are provided.

The PTC heating devices 12 are held in plug-in contact in accommodations 28 provided for this purpose of a partition wall 30 of the housing upper part 6 and are electrically connected and controlled in a connection chamber 29 of a control system 31. Details of this configuration are described in EP 3 334 242 A1 and its U.S. counterpart 10,760,822, both of which originate from the applicant and both of which are incorporated by reference.

The top view according to FIG. 3 shows details of the frame 22, which comprises longitudinal and cross beams 32; 34, from each of which spacer webs 36 protrude inwardly to provide pre-positioning of the PTC element 14 in the frame 22. The upper cross beam 34 in FIG. 3 is surmounted by the contact tongues 18. As FIG. 5 illustrates, the lower boundary of the accommodation space for the PTC element 14 in the frame 22 in FIG. 3 is formed by the lower contact element 16.1, which is connected to the frame 22 by overmolding. FIGS. 3 and 5 also show a metallization 38 which is applied by sputtering or screen printing a metallic layer onto the ceramic material of the PTC element 14, and which forms a respective contact surface 40 on opposite sides of the PTC element 14. Between the contact surface 40 and a circumferential surface of the PTC element 14 characterized by reference sign 42, the ceramic surface of the PTC element 14 is exposed. In this way, an edge 44 circumferentially bounding the contact surface 40 is formed on the main side surface of the PTC element 14 (cf. FIG. 3).

FIGS. 3 and 5 further show plugs of a cured electrically insulating compound 46. The compound 46 is provided between each of the cross beams 34 and the heating cell 24. Otherwise, a gap 48 remaining between the PTC element 14 and an inner circumferential surface of the frame 22 is free of material of the compound 46.

In the course of manufacture, the frame 22 with the lower contact element 16.1 is first produced by overmolding this contact element with a plastic forming the frame 22. In the arrangement shown in FIG. 3 of this intermediate product with the first contact element 16.1 facing downward, the PTC element 14 is then inserted into the frame 22. Discrete dosing of the compound 46 are then introduced between the outer circumferential surface 42 and the frame 22. The second contact element 16.2 is then applied. This further contact element 16.2 abuts against the compound 46, which is then cured by energizing the PTC element 14. Furthermore, curing by an oven process is also possible. Thereafter, the two contact elements 16.1 and 16.2 are connected to the PTC element 14 and the frame 22.

Further manufacturing steps may follow in which additional components are added to the PTC heating device 12, which have been described with reference to FIG. 2.

1. A PTC heating device comprising:
a frame; and
a heating cell accommodated in the frame, the heating cell comprising at least one PTC element made of a ceramic material and contact elements to be assigned different polarity,
wherein the PTC element has contact surfaces formed by a metallization,
wherein the contact elements are each electrically contacted with one of the contact surfaces,
wherein the heating cell is fixed in the frame by an electrically insulating cured compound arranged between an outer circumference of the heating cell and an inner circumference of the frame, and
wherein an edge formed by the ceramic material of the PTC element is provided between the compound and each contact surface.

2. The PTC heating device according to claim 1, wherein each contact surface is framed by a circumferential edge formed by the ceramic material of the PTC element.

3. The PTC heating device according to claim 1, wherein the heating cell is fixed by two to five discrete doses of the compound in the frame.

4. The PTC heating device according to claim 3, wherein each of the discrete doses of the cured compound extends over no more than 20% of a circumferential surface of the heating cell.

5. The PTC heating device according to claim 3, wherein each of the discrete doses of the cured compound extends over no more than 10% of a circumferential surface of the heating cell

6. The PTC heating device according to claim 3, wherein the frame or a segment of the frame is integrally formed with the contact element.

7. An electrical heating device for a motor vehicle, comprising:
a heater housing which comprises inlet and outlet openings for a medium to be heated; and
at least one PTC heating device accommodated in the heater housing, the PTC heating device including
a frame; and
a heating cell accommodated in the frame, the heating cell comprising at least one PTC element made of a ceramic material and contact elements to be assigned different polarity,
wherein the PTC element has contact surfaces formed by a metallization,
wherein the contact elements are each electrically contacted with one of the contact surfaces,
wherein the heating cell is fixed in the frame by an electrically insulating cured compound arranged between an outer circumference of the heating cell and an inner circumference of the frame,
wherein an edge formed by the ceramic material of the PTC element is provided between the compound and each contact surface and
wherein the PTC heating device is coupled in a heat-conducting manner to the medium to be heated.

8. A method of manufacturing a PTC heating device comprising:
applying a metallization on opposite side surfaces of a PTC element made of a ceramic material to provide contact surfaces, wherein the contact surfaces are bounded externally by edges of the ceramic material of the PTC element;
inserting the PTC element into a frame or a segment of the frame and between the frame or the segment and the PTC element; and
introducing an electrically insulating compound at the level of at least one of the edges, by which the PTC element is fixed in the frame after curing.

9. The method according to claim 8,
wherein the frame or a segment of the frame with one of the contact elements is provided as a pre-assembled unit, and
wherein the compound is introduced into the frame or the frame segment and, thereafter, the other contact element is placed on the PTC element such that the compound is provided only between the two contact elements after manufacture of the PTC heating device.

10. The method according to claim 8, wherein the other contact element is first joined to another segment of the frame to form a pre-assembled unit and, thereafter, the contact element is placed on the PTC element.

11. The method according to claim 8, wherein the electrically insulating compound is introduced between an inner circumference of the frame or the segment of the frame and an outer circumference of the heating cell at the level of one of the edges that is assigned to one of the contact surfaces and at the level of another of the edges that is assigned to other of the contact surfaces.
